(19) United States
(12) Patent Application Publication
(10) Pub. No.: US 2025/0153534 A1
(43) Pub. Date: May 15, 2025

(54) TEMPERATURE CONTROL SYSTEM FOR A MOTOR VEHICLE AND METHOD

(71) Applicant: MAGNA STEYR Fahrzeugtechnik GmbH & Co KG, Graz (AT)

(72) Inventors: Nicolai WAGNER, Altdorf (DE); Oliver WAGNER, Altdorf (DE)

(73) Assignee: MAGNA STEYR Fahrzeugtechnik GmbH & Co KG, Graz (AT)

(21) Appl. No.: 18/928,434

(22) Filed: Oct. 28, 2024

(30) Foreign Application Priority Data
Nov. 9, 2023 (DE) 102023131184.0

(51) Int. Cl. B60H 1/00

(52) U.S. Cl. CPC B60H 1/00492; B60H 1/00021; B60H 2001/00085

(57) ABSTRACT

The present disclosure relates to a temperature control system for a motor vehicle, and a method for operating such a temperature control system. The temperature control system includes a first supply air device arranged in a front region of the motor vehicle to receive a first airflow from an external environment and facilitate flow of the first airflow via a first air circuit as supply air into a cabin of the motor vehicle and discharge of the first airflow into the external environment as exhaust air to thereby close the first air circuit. A heat exchange device is arranged in the rear region to receive heat from an exhaust air device, the heat exchange device including a heat pump and heat exchange lines to facilitate return of the heat to the at least one first supply air device. A second supply air device is arranged in the rear region of the motor vehicle to receive a second airflow from the external environment and facilitate flow of the second airflow via a second air circuit through the heat exchange device and discharge of the second airflow into the environment to thereby close the second air circuit.

### CROSS-REFERENCE TO RELATED APPLICATIONS

The present application claims priority under 35 U.S.C. § 119 to German Patent Publication No. DE102023131184.0 (filed on Nov. 9, 2023), which is hereby incorporated by reference in its complete entirety.

### TECHNICAL FIELD

The present disclosure relates to a temperature control system for a motor vehicle according. The present disclosure further relates to a method for operating such a temperature control system.

### BACKGROUND

A heat exchanger which is combined with a heat pump and which is used in an increasing number of vehicles, which in summer can dissipate heat to the environment in the capacity of a condenser and which in winter can receive heat from the environment in the capacity of an evaporator, is positioned primarily in the front of the vehicle in the prior art.

If the residual heat in the cabin air is also intended to be used in the operating situation which is advantageous therefor, an additional heat exchanger is required in the rear of the vehicle according to the German Patent Publication No. DE 10 2020 006 417 A1.

### SUMMARY

The object of the present disclosure is to design the use of a heat exchanger in a particularly efficient manner, in particular regarding the positioning and the advantages as a function of this positioning.

This object is achieved via a temperature control system having the features of claim 1 and via a method according to the present disclosure. Advantageous embodiments of the temperature control system according to the present disclosure are to be regarded as advantageous embodiments of the method according to the present disclosure, wherein the means of the temperature control system are used for carrying out the method steps. Moreover, advantageous developments of the present disclosure are described by the dependent claims, the following description and by the figures.

One aspect of the present disclosure relates to a temperature control system for a motor vehicle, in particular for a passenger motor vehicle, in particular for a passenger motor vehicle which can be electrically operated, having at least one cabin supply air device in the front region and having at least one exhaust air device in the rear region of the motor vehicle, a first airflow being able to be supplied thereby from the environment as supply air via the cabin supply air device into a cabin of the motor vehicle and being able to be discharged thereby back into the environment as exhaust air via the exhaust air device for closing a first air circuit, and having a heat exchange device which is arranged in the rear region, heat from the exhaust air device being able to be received thereby and being able to be returned to the cabin supply air device via an arranged heat pump, and arranged and corresponding heat exchange lines of the temperature control system.

In order to achieve the objects of the present disclosure, it is provided that an additional supply air device for the heat exchange device is arranged in the rear region for receiving a second airflow from the environment and the additional airflow can be discharged back into the environment for closing a second air circuit. Accordingly it is provided to supply and to improve or to optimize at least partially a heat exchange in a temperature control system for motor vehicles, in particular for electrically operated passenger motor vehicles. To this end, different components and functionalities are linked to one another in order to permit an efficient temperature control process.

The temperature control system initially comprises the cabin supply air device which is located in the front region of the motor vehicle. This supply air device makes it possible to conduct a first airflow out of the environment as supply air into the cabin of the motor vehicle. At the same time, an exhaust air device is present in the rear region of the motor vehicle, said exhaust air device being configured to discharge the exhaust air from the cabin and thus to close the first air circuit by the exhaust air being released back into the environment.

However, with the targeted positioning of an additional supply air device in the rear region of the vehicle closely linked to the heat exchange device, it is provided that a second airflow is received from the environment, said second airflow being treated separately from the first supply air device and the first air circuit. This second airflow can also be discharged back into the environment in order to close the second air circuit.

The heat exchange device, which is also located in the rear region of the motor vehicle, is designed such that heat can be received from the exhaust air device and this heat is useable or can be used in an efficient manner. This is made possible via a corresponding heat pump and a network of heat exchange lines which return the received heat to the cabin supply air device.

The connection of the additional supply air device to the heat exchange device is designed to receive from this additional supply air device the second airflow from the environment, whereby a separate second air circuit is produced. This second airflow can be used either for heat pump mode when the cabin is still cold and no residual heat is available from the exhaust air, or it can be used for cooling mode in which the heat exchange device serves as a condenser and dissipates heat to the environment.

In an advantageous embodiment of the present disclosure, it is proposed that the second airflow, which is received by the additional supply air device, can be diverted by the exhaust air device into the environment in the rear region of the motor vehicle. This permits a targeted removal of the second airflow from the temperature control system, in particular when it is no longer required.

Moreover, in a further advantageous embodiment of the present disclosure, an outlet for the airflows is positioned on the exhaust air device so as to be oriented to the rear in the vehicle longitudinal direction. This positioning ensures that the airflows are diverted in an efficient manner from the motor vehicle.

Additionally, in a further advantageous embodiment of the present disclosure, it is proposed that an inlet for the second airflow is arranged on the additional supply air device for the heat exchange device on the underside of the motor vehicle. This arrangement permits a suitable receiving of ambient air for the temperature control circuit and contributes to optimizing the heat use.

In a further advantageous variant of the present disclosure, an inlet for the second airflow is positioned on the additional supply air device for the heat exchange device in the region of a drive train of the motor vehicle. This provides the possibility of using the waste heat of the drive train in an efficient manner and contributing to the temperature control. In a further advantageous embodiment of the present disclosure, it is provided that an inlet for the second airflow on the additional supply air device for the heat exchange device is designed in the form of inlet openings on the outer skin of the motor vehicle. This arrangement makes it possible to allow ambient air to pass directly from outside into the temperature control circuit and contributes to the optimized receiving of fresh air.

It is also advantageous to arrange a first flap of a flap system between the cabin and the exhaust air device. This flap can be opened or closed in order to control the airflow between the cabin and the exhaust air and thus to adapt the temperature control.

Moreover, in an advantageous embodiment of the present disclosure, a second flap of the flap system is positioned between the additional supply air device for the heat exchange device and the exhaust air device. This second flap permits the control of the airflow between the environment and the heat exchange device. The flap system provides the option to use the air circuits individually or in combination, in each case according to the selected operating modes. This significantly increases the flexibility of the temperature control system and permits a precise adaptation of the temperature control to the current requirements and the external conditions.

Finally, in a further advantageous embodiment of the present disclosure, it is provided that the second airflow is received from the environment of the motor vehicle in the rear region via the additional supply air device for the heat exchange device and is discharged back into the environment for closing a second air circuit. This configuration permits a targeted capture of ambient air for the temperature control circuit and contributes to improving the efficiency of the temperature control.

A further aspect relates to a method for operating a temperature control system according to the above aspect, wherein a second airflow is received from the environment of the motor vehicle in the rear region via an additional supply air device for the heat exchange device and is discharged back into the environment for closing a second air circuit.

In other words, the core of the present disclosure thus relates to the optimized positioning of a heat exchanger unit or a heat exchange device in the form of a combined condenser or evaporator in the vehicle rear, which permits the recovery of the residual heat from the cabin exhaust air, thus increasing the efficiency thereof, the use of ambient heat for heat pump mode and the dissipation of heat to the environment in cooling mode.

In the context of this disclosure, therefore, those heat exchangers which are already present in most vehicles are intended to be repositioned from the vehicle front to the vehicle rear and thus into the immediate environment of the cabin ventilation openings.

This heat exchanger can thus be operated via air ducts and air control flaps, either in cabin air, in ambient air or in a mixture of air from both cases.

The provision of these different operating modes is important since a heat pump system can also be operated while the cabin is still cold and thus no use of residual heat is available. Moreover, a cooling mode can be implemented thereby in summer, in which the heat exchanger in the rear functions as a condenser and dissipates heat to the environment. A further relocation of additional heat exchangers, for example water coolers of the vehicle, into the position in the vehicle rear is also conceivable. In each operating mode, an active fan assists with the airflow through the heat exchanger or the heat exchangers as required. The number and positioning of the air control flaps in the air ducts can be varied according to the desired scope of use.

The supply air from the environment can be supplied via openings in the outer skin of the vehicle, for example on the underside or on the side walls. A suctioning of the air from the region of the drive train could also be possible in order to make additional use of the waste heat which is to be anticipated there. The exhaust air from the heat exchanger or the heat exchangers is intended to be guided out of the vehicle in such a manner that negative pressure produced at the vehicle rear in the case of higher travel speeds promotes the airflow and thus relieves the load from the operation of the active fan. The ventilation openings required for this disclosure in the vehicle rear also represent in all probability the most noticeable feature which can be observed from outside, in order to demonstrate the existence of this disclosure.

Further advantages, features, and details of the present disclosure are found in the following description of preferred exemplary embodiments and with reference to the drawings. The features and combinations of features mentioned above in the description, and the features and combinations of features mentioned hereinafter in the description of the figures and/or shown individually in the figures, are not only able to be used in the respectively specified combination but also in other combinations or individually without departing from the scope of the present disclosure.

### DRAWINGS

One or more embodiments of the present disclosure will be illustrated by way of example in the drawings and explained in the description hereinbelow.

FIG. 1 shows a schematic cross-section of a motor vehicle having a possible embodiment of a temperature control system according to the present disclosure.

FIG. 2 shows a schematic cross-section of a rear of the motor vehicle of FIG. 1 having a possible flap system of the temperature control system.

Elements which are the same and functionally the same are provided with the same reference signs in the figures.

### DESCRIPTION

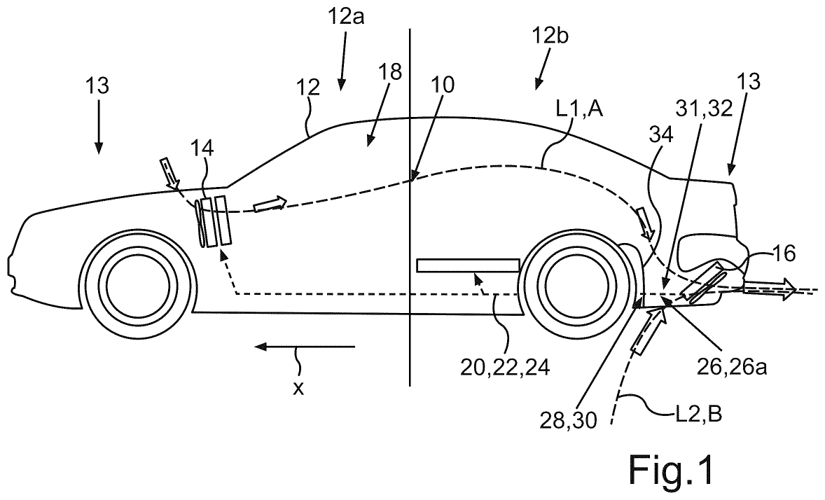

FIG. 1 shows a temperature control system 10 for a motor vehicle 12 which has different components and features in order to permit the temperature control of the cabin 18 of the motor vehicle 12. The system comprises a cabin supply air device 14 in the front region 12a of the motor vehicle 12 and an exhaust air device 16 in the rear region 12b. Via these devices, a first airflow L1 from the environment 13 can pass as supply air into the cabin 18 and can be discharged as exhaust air back into the environment 13 by the exhaust air device 16. A heat exchange device 20 is arranged in the rear region 12b of the motor vehicle 12 and serves to receive heat from the exhaust air device 16. Additionally, a heat pump 22 and corresponding heat exchange lines 24 are arranged in the temperature control system 10. These components make it possible to guide the heat received from the exhaust air device 16 back to the cabin supply air device 14.

An additional supply air device 26 is also arranged in the rear region 12b and is configured to receive a second airflow L2 from the environment 13. This second airflow L2 can either be discharged by the exhaust air device 16 into the environment 13 of the rear region 12b or incorporated in the temperature control circuit.

The temperature control system 10 shown in FIG. 1 for a motor vehicle 12 comprises two air circuits A, B. A first air circuit A or cabin air circuit is primarily configured to provide the temperature control of the cabin 18. This first air circuit A starts with the cabin supply air device 14 in the front region of the motor vehicle 12. This device makes it possible to conduct fresh external air from the environment 13 into the cabin 18. The supplied air or the first airflow L1 is filtered, for example, and optionally preconditioned in order to bring it to a pleasant temperature. The first airflow L1 then passes into the cabin 18 in which it is available for the vehicle occupants. Here the temperature and air quality can be regulated by the temperature control system 10. If required, warm or cold air can be blown into the cabin 18 in order to ensure the comfort of the occupants. After the air has flowed through the cabin 18 and has dissipated its heat, it is discharged by the exhaust air device 16 in the rear region 12b of the motor vehicle 12. The exhaust air is generally removed from the cabin 18 in order to provide space for fresh supply air. This process completes the first air circuit A.

The second air circuit B aims to use in an optimal manner the heat which is present in the ambient air. This second air circuit B starts with the additional supply air device 26 which is positioned in the rear region 12b of the motor vehicle. Ambient air or a second airflow L2 from the environment 13, which does not necessarily have to pass into the cabin 18, is received here.

The received ambient air or the second airflow L2 can be used for various purposes. For example, a heat pump mode can be provided. When the cabin 18, for example, is still cold and no residual heat is available from the exhaust air, the heat pump 22 can be activated in the temperature control system 10. The second airflow L2 is conducted through the heat exchange device 20 in order to receive heat. This heat can then be used in order to heat the supply air in the cabin 18, which reduces the energy consumption.

In summer, however, the second air circuit B can be used in order to use the exhaust air device 16 in the rear region 12b of the motor vehicle 12 as a condenser. In this mode, the heat exchange device 20 dissipates the heat received from the cabin 16 and/or other vehicle systems to the environment 13, whereby the temperature in the motor vehicle 12 and/or in the other vehicle systems is reduced. The flexibility which is provided thereby and which is presented by the integration of two air circuits A and B permits an efficient temperature control of the cabin 18 and/or other vehicle systems in various operating modes and weather conditions. This not only contributes to increasing the comfort of the occupants but also helps to improve or to optimize the energy consumption of the motor vehicle.

It is important to consider that an outlet for the airflows L1 and L2 is provided on the exhaust air device 16, said outlet being oriented to the rear in the vehicle longitudinal direction x. This permits the airflows to be diverted in an efficient manner from the motor vehicle 12. The inlet 26a for the second airflow L2 is arranged on the additional supply air device 26 for the heat exchange device 20 on the underside 28 of the motor vehicle 12. This permits a suitable receiving of ambient air for the temperature control circuit. It is also possible that an inlet 26a for the second airflow L2 is arranged on the additional supply air device 26 for the heat exchange device 20 in the region of the drive train 30 of the motor vehicle 12. As a result, the waste heat of the drive train can be used. Moreover, an inlet 26a for the second airflow L2 on the additional supply air device 26 could be designed in the form of inlet openings 31 in the outer skin 32 of the motor vehicle 12. This would enable ambient air to pass directly from outside into the temperature control circuit.

A first flap 36 of a flap system 34 can be arranged between the cabin 18 and the exhaust air device 16. This flap 36 can be opened or closed in order to control the second airflow L2 between the cabin 18 and the exhaust air device. A second flap 38 of the flap system 34 can also be arranged between the additional supply air device 26 for the heat exchange device 20 and the exhaust air device 16. This second flap 38 permits the control of the second airflow L2 between the environment 13 and the heat exchange device 20. The flap system 34 thus permits the air circuits A and B to be controlled individually or in combination, according to the selected operating modes. This provides flexibility in the temperature control of the cabin 18 and the use of the heat exchange device 20.

In summary, the temperature control system 10 permits the efficient temperature control of the cabin 18 of a motor vehicle 12 by a practical positioning of a heat exchanger in the rear region 12b of the motor vehicle 12. This heat exchanger can be operated in various operating modes, in order to regulate the temperature control as required. The use of ambient air and the recovery of residual heat from the exhaust air contribute to the energy efficiency of the system.

In other words, both air circuits A and B and their respective components in this temperature control system 10 are used for a comprehensive improvement in the temperature control.

A significant feature of this temperature control system 10 is the efficient diversion of the airflows L1 and L2 from the motor vehicle 12. This is achieved by the outlet on the exhaust air device 16 which is oriented to the rear in the vehicle longitudinal direction x. This targeted orientation makes it possible to divert the airflows L1, L2 effectively and, for example, without backing up in the immediate environment 13 of the motor vehicle 12.

The inlet 26a for the second airflow L2 is located on the additional supply air device 26 for the heat exchange device 20 on the underside 28 of the motor vehicle. This positioning is deliberately selected in order to ensure that ambient air can be efficiently received. The underside 28 provides ideal access to ambient air which, in particular, is required for the heat pump mode and the temperature control.

An alternative arrangement is to arrange or to place the inlet 26a for the second airflow L2 in the region of the drive train 30 of the motor vehicle 12. This positioning makes it possible to use in a targeted manner the waste heat of the drive train 30 and to incorporate it in the temperature control circuit.

A further option is to design the inlet 26a for the second airflow L2 in the form of inlet openings 31 in the outer skin 32 of the motor vehicle. This would mean that ambient air passes directly from outside into the temperature control circuit, which permits a particularly efficient receiving thereof.

Moreover a flap system 34 is possible. A first flap 36 is located between the cabin 18 and the exhaust air device 16. This flap can be opened or closed as required, in order to control the first airflow L1 between the cabin 18 and the exhaust air. At the same time, a second flap 38 is provided between the additional supply air device 26 for the heat exchange device 20 and the exhaust air device 16, which permits the precise control of the second airflow L2 between the environment 13 and the heat exchange device 20.

The flap system 34 is exceptionally flexible and provides the option to use the two air circuits A and B individually or in combination, according to the selected operating mode.

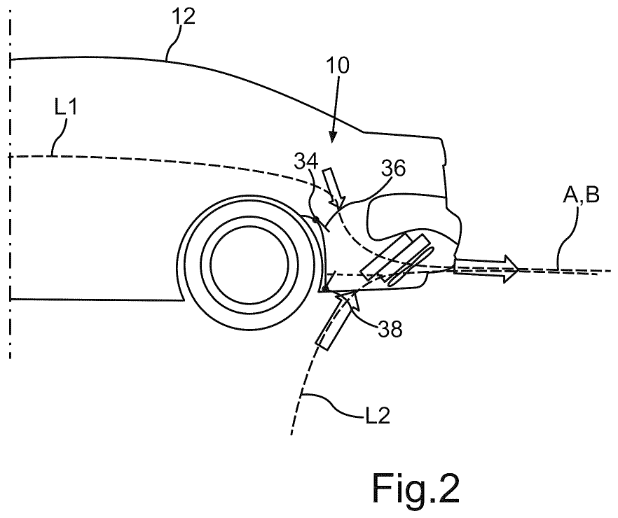

FIG. 2 shows the rear region 12b of the motor vehicle 12 for illustrating a possible flap system 34 of the temperature control system 10.

The flap system 34 consists of the two flaps 36, 38, namely the first flap 36 and the second flap 38. These flaps 36, 38 are required for the control and diversion of the airflows L1, L2 in the two air circuits A, B which are provided in the temperature control system 10 of the motor vehicle 12.

The first flap 36 is located between the cabin 18 of the motor vehicle 12 and the exhaust air device 16. Its main function is to control the first airflow L1 between the cabin 18 and the exhaust air. This control permits the regulation of the exchange of air between the cabin 18 and the environment 13, whereby the temperature control of the cabin 18 is regulated or influenced. The first flap 36 can either be open, closed or in intermediate positions depending on the requirements and operating conditions of the temperature control system 10.

The second flap 38 is positioned between the additional supply air device 26 for the heat exchange device 20 and the exhaust air device 16. Its main task is to regulate the second airflow L2 between the additional supply air device 26 and the exhaust air. Similar to the first flap 36, the second flap 38 can be open, closed or positioned in intermediate positions in order to adapt the second airflow L2. The second flap 38 is required for the control of the second airflow L2 in the second air circuit B.

The functionality and settings of the flaps 36, 38 are important for the overall efficiency of the temperature control system 10 in the motor vehicle 12. The flexibility of the flap system 34 thus permits the airflows L1, L2 to be adapted according to the specific requirements and operating modes of the temperature control system 10.

### LIST OF REFERENCE SYMBOLS

10 Temperature control system
12 Motor vehicle
12a Front region
12b Rear region
13 Environment
14 Cabin supply air device
16 Exhaust air device
18 Cabin
20 Heat exchange device
22 Heat pump
24 Heat exchange lines
26 Supply air device
26a Inlet
28 Underside
30 Drive train
31 Inlet opening
32 Outer skin
34 Flap system
36 First flap
38 Second flap
x Vehicle longitudinal direction
L1 First airflow
L2 Second airflow
A First air circuit
B Second air circuit

What is claimed is:

1. A temperature control system for a motor vehicle, the temperature control system comprising:
at least one first supply air device, arranged in a front region of the motor vehicle to receive a first airflow from an external environment and facilitate flow of the first airflow via a first air circuit as supply air into a cabin of the motor vehicle and discharge of the first airflow into the external environment as exhaust air to thereby close the first air circuit;
at least one exhaust air device arranged in a rear region of the motor vehicle;
a heat exchange device arranged in the rear region to receive heat from the at least one exhaust air device, the heat exchange device including a heat pump and heat exchange lines to facilitate return of the heat to the at least one first supply air device; and
a second supply air device, arranged in the rear region of the motor vehicle, to receive a second airflow from the external environment and facilitate flow of the second airflow via a second air circuit through the heat exchange device and discharge of the second airflow into the environment to thereby close the second air circuit.

2. The temperature control system of claim 1, wherein the second airflow is discharged into the external environment in the rear region by the at least one exhaust air device.

3. The temperature control system of claim 1, wherein:
the exhaust air device includes an outlet for the first airflow and the second air flow, and
the outlet is oriented to the rear region in a longitudinal direction of the motor vehicle.

4. The temperature control system of claim 1, wherein:
the second supply air device includes an inlet for the second airflow, and
the inlet is arranged on an underside of the motor vehicle.

5. The temperature control system of claim 1, wherein:
the second supply air device includes an inlet for the second airflow, and
the inlet is arranged on an underside of the motor vehicle in a region of a drive train of the motor vehicle.

6. The temperature control system of claim 1, wherein:
the second supply air device includes an inlet for the second airflow, and
the inlet is formed as openings on an outer skin of the motor vehicle.

7. The temperature control system of claim 1, further comprising a flap system having a first flap arranged between the cabin and the at least one exhaust air device.

8. The temperature control system of claim 7, wherein the flap system further has a second flap arranged between the second supply air device and the at least one exhaust air device.

9. The temperature control system of claim 7, wherein the flap system permits selective use of the first air circuit and the second air circuit individually or in combination according to selected operating modes.

10. A temperature control system for a motor vehicle, the temperature control system comprising:
a first supply air device to receive a first airflow from an external environment and facilitate flow of the first airflow in a first air circuit as supply air into a cabin of the motor vehicle and discharge of the first airflow into the external environment as exhaust air to thereby close the first air circuit;
an exhaust air device;
a heat exchange device to receive heat from the exhaust air device, the heat exchange device including a heat pump and heat exchange lines to facilitate return of the heat to the first supply air device; and
a second supply air device, arranged in the rear region of the motor vehicle, to receive a second airflow from the external environment and facilitate flow of the second airflow via a second air circuit through the heat exchange device and discharge of the second airflow into the environment to thereby close the second air circuit.

11. The temperature control system of claim 10, wherein:
the exhaust air device includes an outlet for the first airflow and the second air flow, and
the outlet is oriented to the rear region in a longitudinal direction of the motor vehicle.

12. The temperature control system of claim 10, wherein the second supply air device includes an inlet for the second airflow.

13. The temperature control system of claim 12, wherein the inlet is arranged on an underside of the motor vehicle.

14. The temperature control system of claim 12, wherein the inlet is arranged on an underside of the motor vehicle in a region of a drive train of the motor vehicle.

15. The temperature control system of claim 12, wherein the inlet is formed as openings on an outer skin of the motor vehicle.

16. The temperature control system of claim 10, further comprising a flap system having a first flap and a second flap.

17. The temperature control system of claim 16, wherein the first flap is arranged between the cabin and the exhaust air device.

18. The temperature control system of claim 16, wherein the second flap is arranged between the second supply air device and the exhaust air device.

19. The temperature control system of claim 16, wherein the flap system permits selective use of the first air circuit and the second air circuit individually or in combination according to selected operating modes.

20. A method for operating a temperature control system for a motor vehicle, the method comprising:
arranging at least one first supply air device in a front region of the motor vehicle to receive a first airflow from an external environment and facilitate flow of the first airflow via a first air circuit as supply air into a cabin of the motor vehicle and discharge of the first airflow into the external environment as exhaust air to thereby close the first air circuit;
arranging at least one first supply air device in the front region of the motor vehicle;
arranging at least one exhaust air device in a rear region of the motor vehicle;
arranging a heat exchange device in the rear region to receive heat from the at least one exhaust air device, the heat exchange device including a heat pump and heat exchange lines to facilitate return of the heat to the at least one first supply air device;
arranging a second supply air device in the rear region of the motor vehicle;
receiving a second airflow from the external environment of the motor vehicle in the rear region via the second supply air device for flow through the heat exchange device; and
discharging the second airflow into the environment to thereby close the second air circuit.
